(19) United States
(12) Patent Application Publication
(10) Pub. No.: US 2007/0214921 A1
(43) Pub. Date: Sep. 20, 2007

(54) Hydraulic Torque Wrench System

(76) Inventors: Thomas P. Fechter, Jackson, WI (US); Andreas J. Klemm, Beaver Dam, WI (US)

Correspondence Address: QUARLES & BRADY LLP, 411 E. WISCONSIN AVENUE, SUITE 2040, MILWAUKEE, WI, 53202-4497, US

(21) Appl. No.: 10/588,448

(22) PCT Filed: Feb. 4, 2005
(86) PCT No.: PCT/US05/03769

§ 371 Date: May 4, 2007

Related U.S. Application Data
(60) Provisional application No. 60/541,996, filed on Feb. 4, 2004.

(51) Int. Cl. B25B 23/14

(52) U.S. Cl. 81/467; 73/862.23

(57) ABSTRACT

A hydraulic torque wrench system automates the tightening process by continuously operating the torque wrench to alternately advance and retract the wrench cylinder when the advance actuator is held by the operator until the desired pressure or torque is reached. If the advance actuator is released by the operator, the wrench retracts fully and stops advancing. If the advance actuator is not pressed for a period of time while the pump is running, the pump is automatically turned off. The pump can be turned off when the fastener has been tightened to the desired torque or pressure set point, or the pump can continue running in which event the reduction in duration of the alternation cycle between advancement and retraction of the torque wrench cylinder will audibly and visibly signal the operator that the fastener stopping point has been reached. The system can store information correlating pressures with torques for the wrench being used and can include a user adjustable pressure relief valve so it can be used similar to a conventional system. The system controller can be provided with a communications port to communicate with an external computer, either directly or over a network.

### CROSS REFERENCE TO RELATED APPLICATIONS

This claims the benefit of U.S. Provisional Patent Application No. 60/541,996 filed Feb. 4, 2004.

### FIELD OF THE INVENTION

This invention relates to hydraulic torque wrenches, and in particular to pumps for and methods of controlling hydraulic torque wrench tightening operations.

### DISCUSSION OF THE PRIOR ART

Conventional torque wrench pumps typically require the operator to advance and retract the torque wrench cylinder numerous times before final tightening of the fastener is achieved. The required torque set point is obtained by setting an adjustable system relief valve to a pressure setting that corresponds to the desired torque.

A typical sequence requires the operator to press and hold a button (typically an up arrow [⇑]) to advance the torque wrench cylinder, monitor both the system pressure and wrench cylinder position until it is fully extended, then release the button until the wrench cylinder is fully retracted. This interim tightening step must be repeated numerous times until the proper pressure (corresponding to the desired torque setting) is reached prior to full cylinder extension, indicating the proper fastener torque value has been achieved and the final tightening step completed. The entire process can be very tedious, time-consuming, and often necessitates the use of a second individual (one to monitor wrench position and one to monitor system pressure).

### SUMMARY OF THE INVENTION

This invention provides a method and apparatus for precisely controlling and automating a hydraulic torque wrench fastener tightening system. In so doing, valve actuation and system pressure representative of the torque is obtained and is used to monitor the tightening of the fastener and determine a final stopping point for terminating tightening. The invention accomplishes this without adding any attachments to the hydraulic torque wrench.

By utilizing a system controller and system pressure feedback, the tightening (or loosening) process can be automated to substantially simplify operation, reduce cycle time and operator fatigue, and reduce personnel requirements. Such a sequence automates the interim tightening steps, between starting to tighten and reaching the desired torque. The end result is a fastener that reaches a programmable torque set point in a minimal amount of time without continual manual operation of the advance and retract cycles.

The invention provides a hydraulic torque wrench fastener tightening system having a double acting cylinder that turns a socket of the wrench upon an advance of the cylinder and ratchets backward over the socket without turning the socket upon a retract of the cylinder in which, in response to an operator actuating an advance actuator and holding it actuated, the system alternately: (a) applies a pressure to the cylinder to advance the cylinder until a set pressure is reached; and (b) applies a pressure to the cylinder to retract the cylinder. A system of the invention does this in such a way that when a desired torque of the fastener is reached, the alternation cycle between processes (a) applying a pressure to the cylinder to advance the cylinder and (b) applying a pressure to the cylinder to retract the cylinder is reduced in duration. This reduction in duration indicates to the operator that the fastener has reached the desired torque, and will be apparent both audibly and visually to the operator. In addition, the pump can be automatically turned off after the fastener has reached the desired torque.

In one aspect, a hydraulic torque wrench system automates the tightening process by continuously operating the torque wrench to alternately advance and retract the wrench cylinder until the desired pressure or torque is reached. Other aspects of the invention include that: if the advance actuator is released by the operator, the wrench retracts fully and stops advancing; if the advance actuator is not pressed for a period of time while the pump is running, the pump is automatically turned off; the pump can be turned off when the fastener has been tightened to the desired torque or pressure set point or the pump can continue running in which event the reduction in duration of the alternation cycle between advancement and retraction of the torque wrench cylinder will audibly and visibly signal the operator that the fastener stopping point has been reached; the system can store information correlating pressures with torques for the wrench being used; the system can include a user adjustable pressure relief valve so it can be used similar to a conventional system; and the system controller can be provided with a communications port to communicate with an external computer, either directly or over a network.

These and other objects and advantages of the invention will be apparent from the detailed description and drawings.

### BRIEF DESCRIPTION OF THE DRAWINGS

FIG. 1 is a schematic block diagram of a hydraulic torque wrench system incorporating the invention;

FIG. 2 is a schematic circuit diagram of the hydraulics and electronics of the system of FIG. 1; and

FIG. 3 is a flowchart of an algorithm for the system of FIGS. 1 and 2.

### DETAILED DESCRIPTION OF THE PREFERRED EMBODIMENT

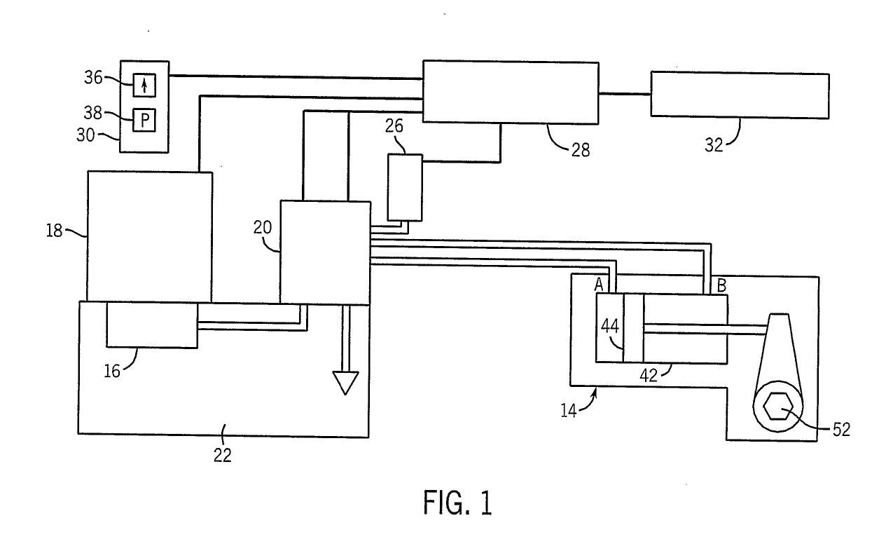

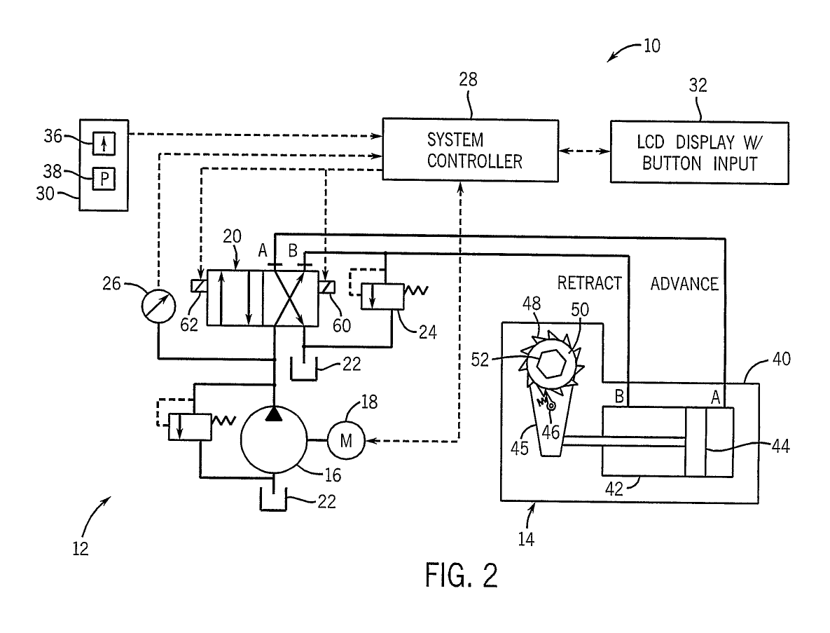

Referring to FIGS. 1 and 2, a hydraulic torque wrench system 10 of the invention includes a power unit 12 and a torque wrench 14. The power unit 12 has a hydraulic pump 16, which may be a fixed displacement pump, driven by an electric motor 18 and supplies hydraulic fluid under pressure through a solenoid operated four way two position valve 20, which may also be manually operable in addition to operation by the solenoids. The pump 16 draws fluid from reservoir tank 22, to which fluid is returned from the wrench 14 by the valve 20. In the position of the valve 20 illustrated in FIG. 2, fluid under pressure from the pump 16 is directed to the retract port B of the wrench and from the advance port A of the wrench to tank 22. When the valve 20 is shifted by the solenoids to its other position, fluid under pressure from the pump 16 is directed to the advance port A of the wrench and from the retract port B of the wrench to tank 22. The system 10 also includes a pressure relief valve 24 that prevents the pressure in the retract line from exceeding a preset limit.

The power unit 12 also includes a pressure transducer 26 that produces an electrical signal representative of pump pressure, which signal is input to system controller 28. The controller 28 also receives as inputs the input from a pendant 30 and from a keyboard button input device 32, that also has an LCD display to display outputs of the system controller 28. The controller 28, pendant 30 and input/display 32 may all be considered part of the power unit 12, although they may be connected to the power unit 12 and to each other by cables that can be unplugged. The controller 28 has outputs to the pump motor 18 and to the valve 20 solenoids to control them. The pendant 30 typically would have at least two buttons, one button 36 that may be labeled with an up arrow to cause the wrench 14 to advance when it is pressed by the operator and held pressed by continuously alternately advancing and retracting the wrench cylinder until the desired torque is reached, and another button 38 that turns the motor 18 off and on. The button 36 may be a momentary contact switch that has to be held to be kept on, and the button 36 may be a toggle type switch that holds its state of being either off or on. The buttons on the device 32 may include, for example, a button to turn the motor on and off, and three buttons (e.g., a menu button and up and down arrow buttons) to scroll through a menu and/or could include a complete computer keyboard for setting input parameters, calibrating or making other settings for the system 10.

The wrench 14 may be of any suitable type. One such type is shown schematically, which is of conventional design. The wrench is designed for extremely rugged and heavy-duty service, having a metal body 40 which a hydraulic cylinder 42 within the body. A piston 44 is slideably received in the cylinder to reciprocate axially as hydraulic fluid is introduced to the cylinder at either the advance A or retract B lines. The piston 44 drives a lever 45 back and forth to rotate the fastener head 52 in one direction. The fastener 52 can be tightened or loosened depending on which side of the wrench is used to drive it.

A fine-toothed spline drive ratchet pawl 46 engages teeth 48 on the outside of the quill shaft 50, which is journalled in the body 14 to rotate the quill shaft 50 clockwise on the advance stroke. The quill shaft 50 drives a socket, which engages head 52 of a fastener to rotate and tighten (or loosen) the fastener. On the return stroke, the ratchet pawl chatters in reverse over the teeth of the shaft, preventing rotating of the socket and fastener. The full stroke of the cylinder typically corresponds to a fraction of a rotation, on the order of 20-30 degrees. Hence the process of fully tightening a fastener can require dozens of cylinder cycles.

The pump unit consists of pump 16, electrical motor 18, valve 20, pressure transducer 26, pendant 30 and system controller 28 incorporating a microprocessor and may also include the display/button unit 32. The pendant 30 is the primary interface for the operator, typically containing buttons to both turn the motor on and off (the P button 38) as well as advance and retract the torque wrench cylinder. To advance with automatically alternating advance and retract cycles, the ⇑ button 36 is pressed (when the pump is on) and to retract and stop advancing the ⇑ button 36 is released (when the pump is on).

The valve 20 is a dual solenoid operated, four way, two position (4-2) valve which controls the porting of the hydraulic fluid through the system. Referring to FIG. 2, actuating solenoid 60 (while deactuating solenoid 62) shifts valve 20 leftwardly to connect retract port B to the pump 16 output and connect advance port A to tank 22. Solenoid 60 may also be referred to as the retract or B solenoid. Actuating solenoid 62 (while deactuating solenoid 60) shifts valve 20 rightwardly to connect advance port A to the pump 16 output and connect retract port B to tank 22. Solenoid 62 may be referred to herein as the advance or A solenoid.

The display/input unit 32 displays system pressure and pump status, and also incorporates buttons which allow the operator to perform tasks such as entering pressure or torque set points and to cycle through display settings.

The pressure transducer 26 measures system pressure upstream of the valve 20 and provides feedback to the system controller to determine the cycling set points of the solenoid valve during normal system operation. A calibration program may be provided in the software run by the controller 28 that allows for calibration of the pressure transducer 6 to the microprocessor of the controller 28 and to the display 32 against a certified master gauge.

The system controller 28 monitors operator inputs from the pendant 30 and input unit 32, torque wrench pressure as measured by the transducer 26, and system status. The controller also controls the system operation and provides outputs to the display 32, the motor 18 and to actuate the valve solenoids 60 and 62.

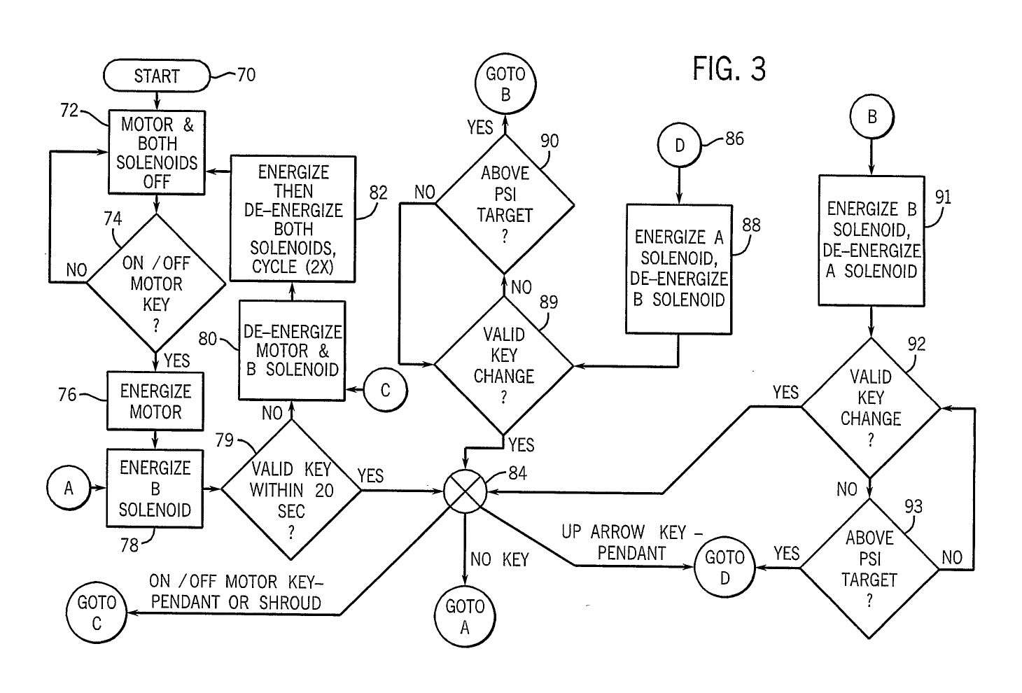

FIG. 3 is a schematic flow chart diagram of the logic used by the controller 28 to control the torque wrench 14. From start 70, the motor and both solenoids are turned off at 72 and the on/off motor key (the P key on the pendant or a similar key on the unit 32) is monitored at 74. When a motor on/off key is pressed by the operator, the pump motor 18 is energized by the controller at 76 and the B (retract) solenoid 60 is energized at 78. The routine then monitors at 79 whether a valid key (either a motor on/off key on the pendant 30 or unit 32 or the ⇑ button 36 on the pendant or a similar advance key on unit 32) is pressed within 20 seconds. If no valid key is pressed, the routine goes to 80 where the motor 18 and retract solenoid 60 are de-energized. Both solenoids 60 and 62 are both alternately energized and de-energized twice at 82 (e.g., solenoid 62 on then off, solenoid 60 on then off, solenoid 62 on then off, solenoid 60 on then off) prior to returning to 72 to loop through the above described routine from that point. The on/off valve cycling at 82 is to release oil pressure between the pump, valves, and hoses by allowing trapped oil a path back to tank once the motor has stopped turning. This ensures there is no pressure left in the hoses after the pump motor 18 is shut off and that the display 32 will read zero pressure.

If a valid key is pressed at 79, an action is taken at 84, depending on which key was pressed. Pressing the ⇑ button 36 on the pendant goes to node D at 86 which results in energizing the A (advance) solenoid 62 and de-energizing the B (retract) solenoid 60 at 88. At 89, it is determined whether there has been a change in the valid keys, for example, if it had been released. If it had been released, the routine goes to 84 and if no valid key is actuated, the routine is returned to step 78 via node A. If at 89 there is no change in the valid keys, for example if the ⇑ button 36 continues to be pressed, the routine goes to step 90 where the pressure is monitored to determine whether it is above the pressure target, which directly correlates to the torque target if the fastener is being tightened. If it is still below the pressure target, the routine returns to step 89. If it is above the pressure target, the routine goes to step 91 via node B.

At step 91, the B (retract) solenoid 60 is energized and the A (advance) solenoid 62 is de-energized. This would indicate that either the lever of the torque wrench has reached the end of its stroke or that the fastener has been tightened to its target torque. In either case, a retraction stroke is initiated. At step 92, it is determined if the valid keys have changed, for example if the ⇑ button 36 is released. If so, the routine goes to step 84. If not, it is determined at step 93 whether the pressure is above the pressure target. If not, step 92 is returned to and the process continues. If the pressure measured by the transducer 26 is above the preset pressure, which indicates that the piston 44 has reached the end of its retraction stroke, the routine goes to node D and picks up at step 88 to continue advancing the wrench.

If at step 84 it is determined that an on/off motor key at either the pendant 30 or unit 32 is toggled to the off position, the routine goes to node C to enter at step 80 where the motor and B (retract) solenoids are de-energized and the process continues to step 82 as described above.

If at step 84 it is determined that there is no key activated (⇑ button 36 is released and motor on/off key toggled to off), the routine goes to node A and step 78 where the B (retract) solenoid 60 is energized and the process continues from there.

From an operator's viewpoint, the sequence of operation is as follows:
1. The operator enters the programmable pressure set point into the system controller 28 via the panel unit 32, which corresponds to the torque desired to be exerted by the wrench 14. The pressure set point is determined by the operator via a pressure to torque conversion table for the particular torque wrench 14 in use.
2. The operator presses and releases the motor key P on the pendant, which turns on the pump motor and energizes the B (retract) solenoid 60. Flow from the pump 16 is ported through the valve 20 into the retract port B of the torque wrench 14. Flow from the advance port A on the torque wrench is ported through the valve 20 into the pump reservoir 22. The torque wrench piston 44 retracts (if the piston is not in a fully retracted position), ratcheting along the quill shaft 50 and leaving the fastener 52 stationary. The piston 44 continues to retract until either the advance button 36 (or the advance button on the unit 32) is pressed or the wrench 14 fully retracts causing the pressure relief setting of the valve 24 to be reached, porting the pump flow to the pump reservoir 22. If the advance button is not pressed within 20 seconds, the system controller will turn off the motor.
3. The operator presses the advance key 36 on the pendant 30 which energizes the A solenoid 62 and de-energizes the B solenoid 60. Flow from the pump 16 is ported through the valve 20 into the advance port A of the torque wrench 14. Flow from the retract port B of the torque wrench 14 is ported through the valve 20 into the pump reservoir 22. The torque wrench piston 44 advances, engaging the quill shaft 50 and causing the fastener 52 to rotate. The piston 44 continues to advance until either the advance button 36 is released or the programmable pressure set point is reached. The set point is reached one of two ways: the cylinder reaches full stroke, preventing further advancement, causing the hydraulic pressure to increase to the set point; or the cylinder is in mid-stroke, however, the torque required to turn the fastener increases to the desired value, which causes the hydraulic pressure to increase to the set point.
4. With the advance button 36 still pressed, once the programmable pressure set point is reached, the system controller automatically retracts the wrench by de-energizing the A solenoid and energizing the B solenoid. The wrench retracts fully, causing the pump pressure to rise to a factory set point that is programmed into the controller 28. The system controller then automatically advances the wrench by energizing the A solenoid and de-energizing the B solenoid (as described in step 3).
5. Upon release of the advance button 36, the system controller will automatically fully retract the wrench, regardless of cylinder position or fastener torque. If the advance button is not pressed again within 20 seconds, the system controller will turn off the motor.

As long as the advance button remains pressed, the system controller will continue this automatic cycling of the wrench (between advance and retract). This saves operation time, as the operator no longer needs to manually identify the end of each advance and retract cycle. It reduces operator fatigue, as the operator no longer needs to press and release control button(s) for each cycle.

When the torque required to turn the fastener increases to the desired value, additional automatic cycles (advance and retract) will be very short in duration due to lack of fastener movement. This shortened duration will be both audibly and visually apparent to the operator that the fastener is at the desired torque. This saves operation time and reduces the personnel involved, since monitoring system pressure is no longer needed.

This also provides full pump flow to the wrench right up to the point of the programmable pressure set point. The extra flow reduces wrench cycle time and provides a hydraulic impact through the wrench to the nut, which speeds the tightening (loosening) process (similar to an impact wrench). It also eliminates the need for a user adjustable pressure relief valve on the pump circuit, which reduces product cost.

Additional features could be programmed into the system. For example, the pump could be automatically shut off when the fastener has reached the desired torque. This could be accomplished by the controller 28 measuring the duration of each advance and retract cycle, and when the duration drops below a corresponding set point, the system controller turns the pump 18 off. Another feature is that the controller could store pre-programmed torque wrench types. This would allow an operator to select from a variety of existing torque wrench models that have torque-to-pressure conversion factors programmed into the system controller. In doing so, the operator could set the tightening (loosening) torque set point to a specific torque value without having to manually look up the conversion value or pressure equivalent. Alternatively, the operator could also manually input a torque-to-pressure conversion factor into the system controller for a specific wrench. In both these cases the equivalent torque value could also be displayed on the LCD display 32 during system operation in lieu of or in addition to pressure. Other features that could be incorporated are that a user adjustable pressure relief valve could be added in the pump circuit to also allow the pump and wrench to be operated in a typical sequence as was used in conventional hydraulic torque wrench systems, and the microprocessor's communication port could be used to export the operation data live to an external computer.

Preferred embodiments of the invention have been described in considerable detail. Many modifications and variations to the preferred embodiments described will be apparent to persons skilled in the art. Therefore, the invention should not be limited to the preferred embodiments described, but should be defined by the claims which follow.

We claim:

1. A hydraulic torque wrench fastener tightening system having a double acting cylinder that turns a socket of the wrench upon an advance of the cylinder and ratchets backward over the socket without turning the socket upon a retract of the cylinder in which, in response to an operator actuating an advance actuator and holding it actuated, the system alternately: (a) applies a pressure to the cylinder to advance the cylinder until a programmable set pressure is reached; and (b) applies a pressure to the cylinder to retract the cylinder; such that when a desired torque of the fastener is reached the alternation cycle between processes (a) applying a pressure to the cylinder to advance the cylinder and (b) applying a pressure to the cylinder to retract the cylinder is reduced in duration and thereby indicates to the operator that the fastener has reached the desired torque.

2. A hydraulic torque wrench fastener tightening system as claimed in claim 1, wherein the process of (b) applying a pressure to the cylinder to retract the cylinder is terminated when a set pressure is reached.

3. A hydraulic torque wrench fastener tightening system as claimed in claim 1, wherein the indication to the operator that the fastener has reached the desired torque is an audible indication.

4. A hydraulic torque wrench fastener tightening system as claimed in claim 1, wherein the indication to the operator that the fastener has reached the desired torque is a visual indication.

5. A hydraulic torque wrench fastener tightening system as claimed in claim 1, wherein after the fastener has reached the desired torque the system shuts off a motor that drives a pump of the system after a certain time period following reaching the desired torque.

6. A hydraulic torque wrench fastener tightening system as claimed in claim 1, wherein the pump is automatically shut off when the fastener has reached the desired torque.

7. A hydraulic torque wrench fastener tightening system as claimed in claim 6, wherein the pump is shut off by the system in response to a reduction in the duration of the alternation cycle between processes (a) applying a pressure to the cylinder to advance the cylinder and (b) applying a pressure to the cylinder to retract the cylinder.

8. A hydraulic torque wrench fastener tightening system as claimed in claim 1, wherein the system stores information to convert pressure measurements to torques applied by the wrench.

9. A hydraulic torque wrench fastener tightening system as claimed in claim 1, wherein the system includes a user adjustable pressure relief valve.

10. A hydraulic torque wrench fastener tightening system as claimed in claim 1, wherein the system has a port to communicate with an external computer.

11. A hydraulic torque wrench fastener tightening system as claimed in claim 1, wherein the pump is shut off if the advance actuator is not actuated for a period of time.
